(19) United States
(12) Patent Application Publication
(10) Pub. No.: US 2007/0295412 A1
(43) Pub. Date: Dec. 27, 2007

(54) Emission Control Devices

(76) Inventors: Adrian Menzell, Queensland (AU); Patrick Baker, Queensland (AU); John Kostic, Queensland (AU)

Correspondence Address: Martin P. Hoffman;Hoffman, Wasson & Gitler, 2461 South Clark Street, Suite 522, Arlington, VA, 22202, US

(21) Appl. No.: 10/578,311

(22) PCT Filed: Nov. 3, 2004
(86) PCT No.: PCT/AU04/01518

§ 371 Date: Jan. 3, 2007

(30) Foreign Application Priority Data
Nov. 4, 2003 (AU) 2003906094

(51) Int. Cl. B03C 1/00

(52) U.S. Cl. 137/544

(57) ABSTRACT

An emissions control device including an elongate body portion having a plurality of channels which are angularly orientated to each other, and each channel having at least one magnet positioned in the channel, the at least one magnet having a polar axis orientated to create magnetic fields directed at a common site adjacent to the body portion.

### TECHNICAL FIELD

The present invention relates to emission control devices and in particular to emission control devices used in conjunction with electronically controlled fuel injection systems.

### BACKGROUND ART

It is now accepted that the treatment of a body of fluid with magnetic fields is capable of providing varying beneficial effects.

Magnetic devices for treating fuels have been proposed in the past and descriptions of such devices can be found in:
International Patent Application No. WO 99/23381
U.S. Pat. No. 5,558,765
U.S. Pat. No. 5,161,512
International Patent Application No. WO 00/31404.
Australian Patent Application No. 2001258057

Authorities throughout the world are moving to encourage efficiencies of petrol and diesel engines including non-road engines and in particular regulating to encourage manufacturers to reduce harmful emissions from engines.

Most modern motor vehicles are fitted with petrol injection systems, either mechanical or electronic.

In such a system, injectors open to spray fuel into an airstream in an inlet duct in a fuel rail. The injectors are mounted in the intake manifold so that they spray fuel directly at the intake valves. A pipe called the fuel rail supplies pressurized fuel to all of the injectors.

Fuel rails for modern injection systems are accessible and accordingly, provide a site to mount a treatment device.

It is an object of the present invention to provide a device and methodology for treating fuels via the fuel rail of a fuel injection system with a view to reducing harmful emissions.

Further objects and advantages will become apparent from the ensuing description which is given by way of example only.

### DISCLOSURE OF INVENTION

According to the present invention, there is provided an emissions control device comprising

(a) an elongate body portion having a plurality of channels which are angularly orientated to each other, and

(b) each channel having at least one magnet positioned in the channel, the at least one magnet having a polar axis orientated to create magnetic fields directed at a common site adjacent to the body portion.

Each channel is most suitably oriented at approximately 120 degree intervals to each other channel. Each channel typically has an open face to allow insertion of the magnets into the channel or replacement of the magnets.

The open faces are radially spaced at approximately 120 degree intervals.

The device may include a tubular cover which houses the body portion and provides an opening common with the common site. The cover may be attachable relative to the body portion to secure the magnets provided in the various channels.

The at least one magnet mounted in a first of the channels may be a neodymium iron boron magnet. Preferably, a plurality of magnets of this type are provided although alternative configurations of magnet numbers and types of magnets may be used according to the present invention.

Magnets mounted in a second and third channels may be ferrite or neodymium iron or boron magnets. Again, a plurality of magnets of this type may be provided although alternative configurations of magnet numbers and types of magnets may be used according to the present invention. According to the most preferred embodiment of the present invention, a single bar magnet may be provided in the second and third channels.

The cover may be fabricated or moulded from aluminium tubestock.

According to the present invention, there is provided a method of treating air fuel/fuel mixtures of an engine having a fuel injection system comprising mounting a device as aforesaid coaxially with a fuel intake rail of a fuel injection system.

The device may be mounted externally of the fuel rail.

The device may be mounted within or partially within the fuel rail.

Without wishing to be limited by theory, the inventors of the present invention have found that the imposition of a magnetic field with particular alignments and/or cross alignments may affect the ability of hydrocarbon fluid particles to atomize. In particular, an increase in the effectiveness of the atomisation of the hydrocarbon fluid was realised.

The general laws of physics imply that the smaller a particle is, the lower the surface tension of that particle and the lower the weight of the particle. Smaller particles therefore result in an increase suspension time of a particle of hydrocarbon fluid as it travels the distance through the intake manifold form the area of magnetic influence of the device according to the present invention and into the combustion chamber.

The hydrocarbon fluid velocity when injected (as well as the air velocity) through the intake manifold may be influential in keeping hydrocarbon fluid particles suspended in the air and the ability to suspend more particles for a longer period may be enhanced if the hydrocarbon fluid articles are smaller and lighter. The greater the amount of fluid in suspension on reaching the combustion chamber, the greater the hydrocarbon fluid particle surface area exposed to air at the point of combustion, thereby increasing the rate of burn, the efficiency of burn and completeness of burn. One result may be an increase in power generated per unit of hydrocarbon fluid and a decrease in noxious exhaust gases produced due to increase burn efficiency.

One way in which the magnetic field may affect the size of the hydrocarbon fluid particles upon atomisation is by affecting the viscosity of the hydrocarbon fluid. This may occur by the action of the magnetic field aligning the hydrocarbon chains in the hydrocarbon fluid.

The alignment action may be effected because the hydrocarbon chains may exhibit a degree of paramagnetism. A paramagnetic material is one whose atoms may have permanent dipole moments, but permanent no permanent magnetism exists outside the influence of an external magnetic field. If a magnetic field is applied to such a material, the dipole moments try to line up with the magnetic field, but are prevented from becoming perfectly aligned by their random thermal motion. Because the dipoles try to line up with the applied field, the susceptibilities of such materials are positive, but in the absence of the strong ferromagnetic effect, the susceptibilities are rather small. If on the average only a relatively small fraction of the atoms are aligned with the field (say 30% or less), then the magnetization obeys Curie's law:

$$M = C ( \frac{{B}_{ext}}{T} )$$

where C is a constant (different for each different material), where T is the temperature in kelvins, and where Bₑₓₜ is the applied magnetic field. Curie's law says that if Bₑₓₜ is increased, the magnetization increases (the stronger magnetic field aligns more of the dipoles). It also says that if the temperature is increased, the magnetization decreases (the increased thermal agitation helps prevent alignment). Curie's law only works for samples in which only a relatively small fraction of the atoms are aligned, on the average, with the magnetic field. When the aligned fraction becomes larger, Curie's law no longer holds because it predicts that the magnetization just goes up forever with increasing applied magnetic field Bₑₓₜ. But this can't be true because once the dipoles are 100% aligned, further increases in the magnetization are impossible. When this happens we say that the material is saturated, and further increases in Bₑₓₜ or decreases in T will not change the magnetization very much because the atoms are about as aligned as they can get.

When a paramagnetic material is placed in a strong magnetic field, it becomes a magnet, and as long as the strong magnetic field is present, it will attract and repel other magnets in the usual way. But when the strong magnetic field is removed, the net magnetic alignment is lost as the dipoles relax back to their normal random motion.

The effects of the alignment of the hydrocarbon chains may allow the reduction in size of the hydrocarbon fluid particles when formed. (The length of time that the chains remain aligned is dependent upon several influences including but not limited to conduit surface inter-reaction, fluid density, and the degree of tortuosity of the pathway through which the particles flow, which is particularly relevent in combustion engines.)

The effects of this may be seen from the following example using a unit scale:

If one particle of atomised hydrocarbon (calculated as a uniform sphere and identified as “A”) is 12 arbitrary units in diameter, then the surface area of that particle would be 4πr², or as the radius of this particle in 6 units, approximately 452.38 square units of surface area.

The volume of that same sphere A would be 4/3πr³ or approximately 904.8 cubic units.

If the magnetic influence has an effect of changing the packing factor of the hydrocarbon chains by 20% with an effect if a size reduction in the atomized hydrocarbon particle by 20%, then the above calculation for surface area and volume of a particle 20% smaller than 12 units in diameter or 9.6 units in diameter (Particle “B”) would be as follows:

Surface area would be 289.5 square units and a volume of 463.2 cubic units.

If the total volume of all hydrocarbon atomised as it enters the system is constant, the difference in volume between particle A and Particle B requires that approximately 2 particle B's are created instead of 1 particle A (904.8/463.2 equal 1.953 or approximately 2). If two B particles are created, then the corresponding surface area of these two B particles is 289.5 square units×2 or 579 square units. The surface area of particle A is 452.38 square units. Therefore, the total increase in surface area realised by providing two smaller volume particles having the same volume as a single larger particle is 126.62 square units, that is, the surface area of the smaller particles exhibit a surface area increase of approximately 28%.

The increase in surface area available for contact with the air and an increase surface area available for the combustion process, an increase in burn efficiency is realised. The increase burn efficiency may result in a lower level of emissions and more power per unit of hydrocarbon fuel.

### BRIEF DESCRIPTION OF THE DRAWINGS

Aspects of the present invention will now be described with reference to the accompanying drawings in which:

FIG. 1 is an exploded perspective view of an emissions control device according to one possible embodiment of the present invention, and

FIG. 2 is an end/sectional view of the emissions device of FIG. 1 applied to the fuel rail of an injection system, and

FIG. 3 is a diagrammatic perspective view of the device of FIG. 1 applied to the fuel rail of an injector system of an engine.

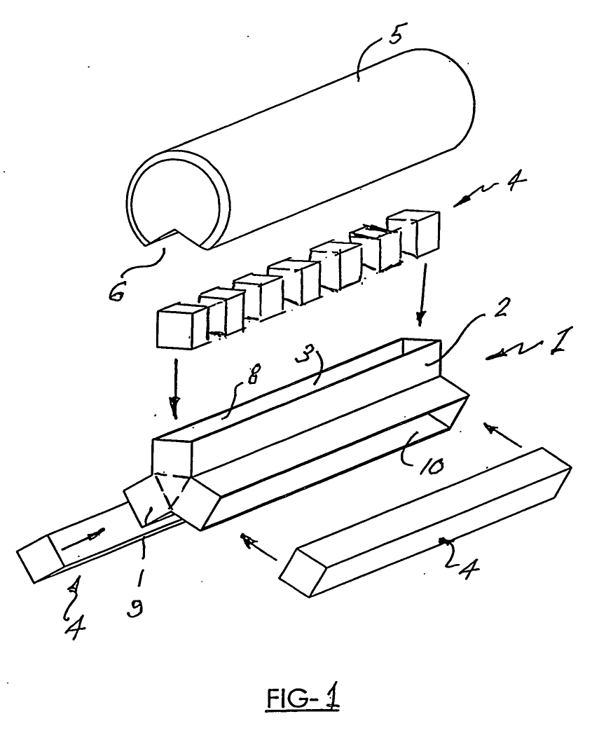

### DESCRIPTION OF PREFERRED EMBODIMENT

With respect to the drawings, a device according to the present invention can comprise an elongate body generally indicated by arrow 1, the body providing a plurality of channels 2 therein, each having angularly orientated open faces 3.

A plurality of magnets generally indicated by arrow 4 are positioned in the channels having polar axes as indicated which create magnetic fields directed at a common site adjacent to the body.

The open faces are radially spaced by approximately 120 degrees.

The device may include a tubular cover 5 which houses the body 1 and provides an opening 6 common with the common site.

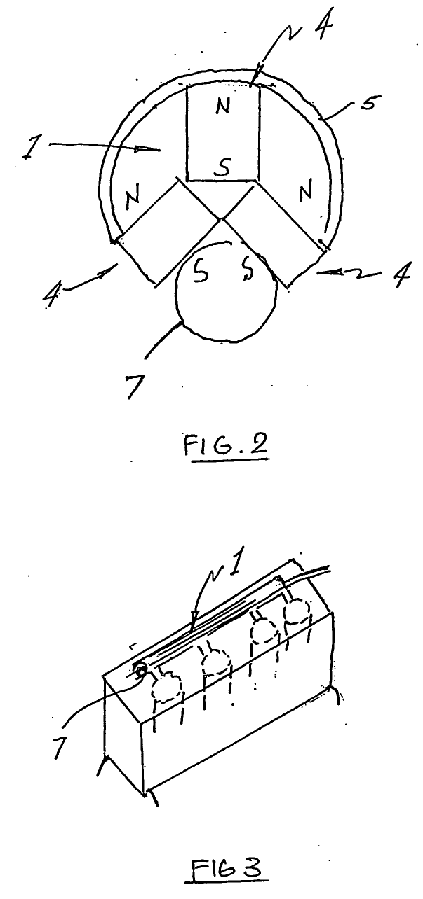

The device is mounted on a common fuel rail 7 (see FIGS. 2 and 3) which defines the common site for the magnetic field.

The magnets may be separate magnets or may be in bar form.

The magnet types may vary, for example, the magnets in a first of the channels 8 may be neodymium iron boron magnets whilst magnets in channels 9 and 10 may be ferrite magnets of lesser strength.

Voids within the interiors of the cover may be filled or partially filled with a non-magnetic filler e.g. an epoxy.

Whilst the device of the present invention is primarily concerned with reducing the level of undesirable emissions from engines, it is likely that it will also reduce fuel consumption.

The magnetic field applied to a fuel line is directly applied to fuels by the magnets immediately adjacent the fuel line. It is supposed that the magnetic lines of flux from the magnets immediately adjacent the fuel line deflect and spread throughout the cross-section of the fuel line and the effect of the stronger magnet is to assist the process.

It is also supposed that an alignment of the carbon chains in the fuel in a specific way takes place. Testing has indicated that with specific magnetic field alignment, the viscosity of the liquid fuel is affected.

Examples of this testing is given in the table below, in which the test was carried out on a vehicle with an electronically controlled fuel injection system.

Test No. 1

Vehicle: Holden Commodore, Model VN, Year 1991.

The test was carried out at a constant 60 kph. The operating temperature of the engine was verified prior to testing as temperature can also effect the viscosity of the fluid. The test was carried out at ambient conditions (humidity and temperature) which were recorded and remained within a 5% range throughout the test. The emissions in the gaseous exhaust were then analysed.

Base-Line Sets:

| | | | |
|---|---|---|---|
| HEX ppm | NOX ppm | CO % | CO₂ % |

Base-line sets:

| | | | | |
|---|---|---|---|---|
| Test 9/7 A | 60 | 535 | 0.44 | 14.67 |
| Test 9/7 B | 53 | 509 | 0.47 | 14.82 |
| BASE-LINE | 56.5 | 522 | 0.45 | 14.745 Averaged |

Device on

| | | | | |
|---|---|---|---|---|
| Test 9/7 C | 39 | 519 | 0.28 | 14.55 |
| Test 9/7 D | 34 | 495 | 0.27 | 14.44 |
| DEVICE | 36 | 504 | 0.27 | 14.495 Averaged |
| % Improvement | 36.2% | 2.8% | 40% | 1.7% |

Test No. 2.

Conditions as Above with Speed Increase to a Constant 80 KPH

| | | | |
|---|---|---|---|
| HEX ppm | NOX ppm | CO % | CO₂ % |

Base-line set:

| | | | | |
|---|---|---|---|---|
| Test 7/10/C | 114 | 1125 | 0.54 | 14.82 |

Device on

| | | | | |
|---|---|---|---|---|
| | 79 | 1056 | 0.36 | 14.68 |
| % Improvement | 30.7% | 53% | 33.3% | 0.9% |

The benefits of the device according to the present invention can therefore be seen from the above tests.

What is claimed is:

1. An emissions control device for an engine having a fuel system, the device including
(a) an elongate body portion having a plurality of channels which are angularly orientated to each other in a Y-shaped configuration, the Y-shaped configuration located in association with a fuel conduit or rail, and
(b) each channel having at least one magnet positioned in the channel, the at least one magnet having a polar axis orientated to create magnetic fields directed at a common site adjacent to the body portion and within at least a part of the fuel conduit or rail.

2. An emissions control device as claimed in claim 1 wherein the open faces are radially spaced at approximately 120 degrees.

3. An emissions control device as claimed in claim 1 including a tubular cover which houses the body and provides an opening common with the common site.

4. An emissions control device as claimed in claim 1 wherein the magnet is mounted in a first of the channels are neo dymium magnets.

5. An emissions device as claimed in any one of claim 1 wherein the magnets mounted in a second and third channels are ferrite magnets.

6. (canceled)

7. A method of treating air fuel mixtures of an engine having a fuel injection system comprising mounting a device as claimed in claim 1 mounted in association with a fuel intake rail of a fuel injection system.

8. A method as claimed in claim 7 wherein the device is mounted externally of the fuel rail.

9. A method as claimed in claim 7 wherein the device is mounted within the fuel rail.

10. An emissions control device as claimed in claim 3 wherein the fuel conduit or rail of the fuel system is at least partially received in the opening.

11. An emissions control device as claimed in claim 3 wherein the opening is an elongate opening defined between a pair of channels of the Y-shaped configuration.
